(19) United States
(12) Patent Application Publication
(10) Pub. No.: US 2006/0072764 A1
(43) Pub. Date: Apr. 6, 2006

(54) Audio based data representation apparatus and method

(75) Inventors: Mark Jozef Willem Mertens, Eindhoven (NL); Daniel Willem Elisabeth Schobben, Eindhoven (NL); Ronaldus Maria Aarts, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/535,298

(22) PCT Filed: Nov. 13, 2003
(86) PCT No.: PCT/IB03/05131

§ 371 Date: May 17, 2005

(30) Foreign Application Priority Data
Nov. 20, 2002 (EP) 02080357.3
Dec. 30, 2002 (EP) 02080570.1

(51) Int. Cl. H04R 5/02; H04R 29/00

(52) U.S. Cl. 381/56; 381/310

(57) ABSTRACT

The data representation apparatus (100) for representing data by means of an audio signal (o), contains an processing unit (102) arranged to deliver the audio signal (o) with a characteristic (C) dependent on a positionless data variable (p) capable of having a first value (206) and a second value (208), whereby the data representation apparatus (100) comprises a mapping unit (132), arranged to map by means of a mapping the first value (206) of the data variable (p) to a first position (216) in three-dimensional space, and the second value (208) of the data variable (p) to a second position (218) in three-dimensional space, and the audio processing unit (102) is arranged to change the characteristic (C), resulting in the audio signal appearing to originate from the first position (216) for the data variable (p) having the first value (206) respectively the second position (218) for the data variable (p) having the second value (208), to a user (200) listening to the audio signal (o). A system containing such a data representation apparatus (100) and a source of data, a source of music and a sound production is also described, as well as a method.

The invention relates to a data representation apparatus for representing data by means of an audio signal, comprising an audio processing unit arranged to deliver the audio signal with a characteristic dependent upon a positionless data variable capable of having a first value and a second value.

The invention also relates to a system for representing data by means of an audio signal, comprising:

an audio source arranged to deliver an input audio signal;

a source of a data variable capable of having a first value and a second value;

a sound production device; and

a data representation apparatus for representing data by means of the audio signal, the data representation apparatus comprising an audio processing unit arranged to deliver the audio signal to the sound production device with a characteristic dependent on the data variable.

The invention also relates to a method of representing data by means of an audio signal, comprising an audio processing step delivering the audio signal with a characteristic dependent on a data variable, capable of having a first value and a second value.

The invention also relates to a computer program for execution by a processor, enabling the processor to execute the method.

The invention also relates to a data carrier storing the computer program.

An embodiment of such a data representation apparatus is known from U.S. Pat. No. 6,230,047. The known apparatus receives as a data variable a heart rate from a pulse monitor. Based on the heart rate, a corresponding rhythm pattern is fetched by an audio processing unit from a rhythm pattern memory, storing prerecorded rhythms of e.g. drums. The audio processing unit creates a continuous audio signal from the selected rhythm, having a tempo characteristic in accordance with the particular measured heart rate.

A disadvantage of this kind of audio feedback of a measurement is, that it is difficult for a user to judge which particular value of the data variable is actually represented, and hence it can only be used in applications where only a reference point of the measurement is required, and only deviations from the reference point have to be judged by the user. The known apparatus e.g. is used by joggers, who tend to adjust their training so that their heart rate corresponds to the rhythm.

It is an object of the invention to provide a data representation apparatus for presenting data by means of an audio signal, which presents the data in a way which is relatively easy to quantify by a user.

The object is realized in that

the data representation apparatus comprises a mapping unit, arranged to map the first value of the data variable to a first position in three-dimensional space, and the second value of the data variable to a second position in three-dimensional space; and

the audio processing unit is arranged to change the characteristic, resulting in the audio signal appearing to originate from the first position for the data variable having the first value respectively the second position for the data variable having the second value, to a user listening to the audio signal. Representation of data by means of an audio signal is useful for several reasons, e.g.:

a user can use his visual faculties for something else, like watching TV, driving a car, or looking where to put his feet when running;

auditive representation may be useful if a lot of data is already represented visually;

there may be environments in which visual information is less useable, e.g. during the night, or in thick smoke; or

it may be useful for people with reduced visual acuity.

Existing auditive representation system typically change the volume, pitch, tempo or balance of an audio signal, but for most people this is difficult to quantify. E.g. most people are bad in judging the exact pitch of a sound.

Humans can however judge rather accurately from which direction a sound originates. Their judgement of values of angles in space is also not too coarse. Hence, just as e.g. a dial of a clock can visually show time with a relatively good accuracy, the data representation apparatus according to the invention makes it possible to generate a virtual dial of virtual audio source positions around a user's head. Corresponding virtual audio sources indicating the value of the data variable on the virtual dial, are generated by means of real sound production devices, but a user perceives the sound as coming from a predetermined position or direction. Apart from a virtual dial, any geometrical distribution of virtual sound sources representing data variable values around a user's head can be realized by the audio processing unit. Instead of presenting a virtual sound source in a fixed position, the position is determined by the value of the data variable, which does not have a naturally related position in space. E.g. a temperature measured by a thermometer has no naturally associated position, but it can be measured on a one-dimensional coordinate axis though. It has to be mapped to a point in space. If the data variable has a first value, the virtual sound source is presented in a first position, and if the data variable has a second value, the virtual sound source is presented in a second position.

A number of values of the data variable are mapped to a locus in space. The word locus is used in its meaning “The set or configuration of all points whose coordinates satisfy a single equation or one or more algebraic conditions.” The locus can be a one-, two-, or three-dimensional manifold and of any extent. E.g. temperature values can be mapped to a one-dimensional circle around a user's head, or to a two-dimensional circular strip with a thickness.

Multichannel sound reproduction already exists. E.g. headphone virtualizers simulate e.g. 5 loudspeakers required in Dolby 5.1 sound reproduction as virtual loudspeakers. However the audio information for these sound channels—leading to virtual sound source positions—is already present in the audio signal. The virtual sources are supposed to roughly coincide with the real positions of instruments during recording. These physical sound sources naturally have a position. E.g. if in a recording of an orchestra a violin was present to the right of a listener—or a microphone in the position of a listener—during reproduction, the virtual violin should also be perceived as coming from more or less the same spot to the right of the listener. Stereo and multichannel sound reproduction is often based on heuristics, so the position of a virtual sound source need not be exactly the same as the original position of the recorded sound source. But, the loudspeakers, or virtual loudspeakers in a headphone virtualizer, are put in a fixed position and stay there. This implies that the position of virtual sound sources is determined by the actual audio signals sent to the loudspeakers. In the data representation apparatus, the positioning of the virtual sound source depends on the data variable, e.g. a measurement such as the time. Since time has no obvious position—it is a positionless or non positional variable—, a mapping is needed of time values to a locus in three-dimensional space around a user's head, where the corresponding times should be represented by means of virtual sound sources. E.g. at twelve o'clock, a chime sound is produced straight above the user's head.

In an embodiment, the audio processing unit comprises a filter for applying a head related transfer functions (HRTF) to an input audio signal to obtain the output audio signal appearing to originate from the first position respectively the second position. A simple variant of the audio processing unit comprises panning means to simulate the virtual sound source position by means of simple stereo panning. By varying amplitudes and/or delays of a first and a second audio signal component destined for two respective stereo loudspeakers, a locus of virtual sound source positions between the loudspeakers can be traversed. However, better controllability of the virtual sound source position can be obtained by processing an input audio signal from an audio source with user specific head related transfer functions (HRTFs), yielding for each desired virtual sound source position an output signal with two component audio signals: a first component for a left loudspeaker and a second component for a right loudspeaker of e.g. headphones.

The data representation apparatus may comprise a data variable distributor capable of delivering the data variable derived from a measurement from a measurement device to the audio processing unit. It is advantageous if the data variable is directly derived from a measurement from a measurement device, e.g. being the measurement itself. The data variable distributor is arranged to transmit measurement data variables to the audio processing unit for positioning the virtual sound source. Additionally or alternatively, the data variable may originate from a data variable delivery device. E.g. the data variable may be stored in a memory means or arrive over Internet. The data variable distributor is capable of transmitting either a data variable from a single selected data variable source, or data variables from different sources. The data variable distributor may also be configured so as to only transmit data variable values with a predetermined priority.

In a modification of the apparatus or its embodiment, the mapping unit is arranged to map a collection of nominal values of the data variable to predetermined regions of three-dimensional space. Nominal data variable values are values which fall in a number of classes, e.g. instead of specifying temperatures with a numerical scale such as the Celsius scale, the temperatures can be described as “very hot”, “hot”, “tepid” and “cold”. These nominal values can be mapped e.g. to four quadrants above the user's head. There is no natural ordering relation between nominal data values, so the mapping may contain e.g. a table specifying for each nominal data value a link between the value and a position in space.

In another modification of the apparatus or its embodiment, the mapping unit is arranged to map a collection of numerical values of the data variable to positions on a curvilinear locus in three-dimensional space. In case also a numerical data variable should be presented, the mapping unit is arranged to specify a curvilinear locus around the user, and to divide it in intervals to which intervals of the numerical data variable should be mapped. The locus may be a one-dimensional manifold, but may also be a two-dimensional or three-dimensional manifold in space. Positions along the locus may be equidistant or a more complex relation between the data variable values and the positions along the locus may be used.

It is advantageous if specification means are comprised, arranged to allow a specification of a preferred mapping for the mapping unit. E.g. if the user is driving a car, he might want his speed to be presented by means of a virtual sound source. Accidents happen because a driver has only e.g. two seconds to react, and if he is not wasting that precious time looking at his instruments, he may be able to break in time. When driving on the highway, the allowed speed is 120 km/h. So he might want to specify a dial where 120 km/h corresponds to a virtual sound source straight in front of him, and speeds up to 130 km/h are presented up to 90 degrees on the right. For lower speeds, the 90 degrees on the left may represent speeds down to 80 km/h; However, when driving in a built-up areas the speed limit is 50 km/h, so the driver may want to specify an alternative mapping, in which speeds between 25 km/h and 60 km/h are mapped from left to right. Especially if a number of dials are presented simultaneously, it is useful if the mappings map to distinct regions of space, allocated by the user, especially if similar sounding sounds are allocated to the virtual sound sources.

It is also advantageous if selection means are present, arranged to allow representation of a first set of data variable values by a first type of the audio signal and a second set of data variable values by a second type of the audio signal. E.g. to increase the accuracy of quantification by the user of the represented data value in excess of the user's sound localization accuracy, nearby values on a virtual dial can be represented with different virtual sounds. E.g. each set of ten consecutive values is represented by means of sound of increasing pitch. The first value sounds low pitched, the tenth value high pitched, the eleventh value low pitched again, and so on. Also, when different dial loci or in general data variable mappings are presented simultaneously, their respective data values can be presented by sounds which sound different to the user. In this way he can learn that e.g. the whistle represents the speed measurement, the chime the clock, and so on.

The system for presenting data by means of an audio signal is characterized in that

the data representation apparatus further comprises a mapping unit, arranged to map by means of a mapping the first value of the data variable to a first position in three-dimensional space, and the second value of the data variable to a second position in three-dimensional space; and

the audio processing unit is arranged to change the characteristic, resulting in the audio signal appearing to originate from the first position for the data variable having the first value respectively the second position for the data variable having the second value, to a user listening to the audio signal.

The method of presenting data by means of an audio signal, is characterized in that

a mapping is effected mapping the first value of the data variable to a first position in three-dimensional space, and the second value of the data variable to a second position in three-dimensional space; and

the audio processing step changes the characteristic, resulting in the audio signal appearing to originate from the first position for the data variable having the first value respectively the second position for the data variable having the second value, to a user listening to the audio signal.

These and other aspects of the data representation apparatus, the system, and the data carrier according to the invention will be apparent from and elucidated with reference to the implementations and embodiments described hereinafter, and with reference to the accompanying drawings, which serve merely as non limiting illustrations.

In the drawings:

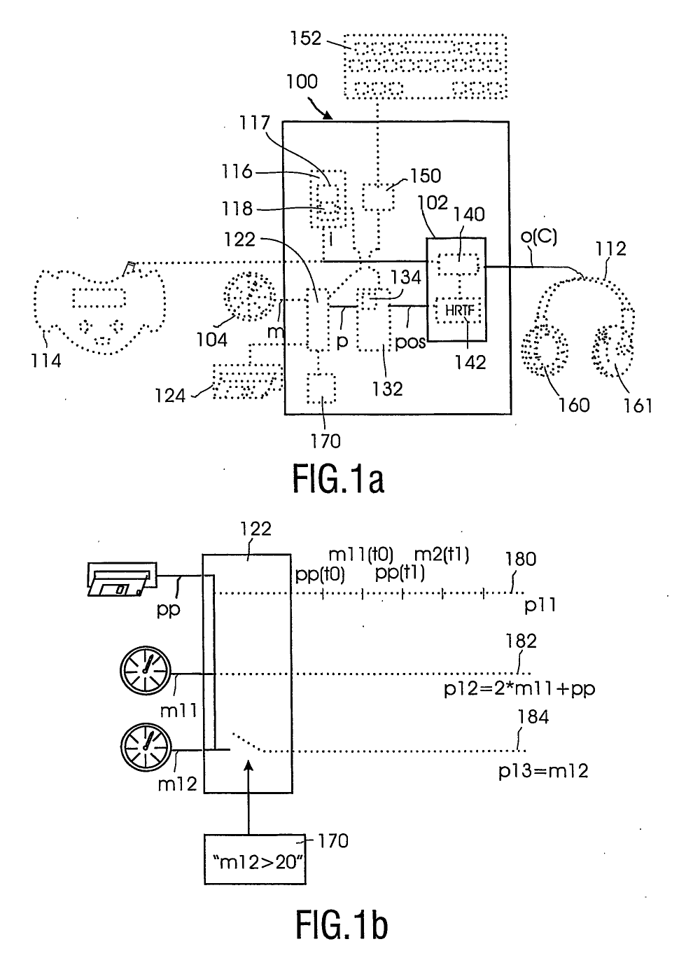

FIG. 1a schematically shows the data representation apparatus;

FIG. 1b schematically shows some embodiments of a data variable distributor;

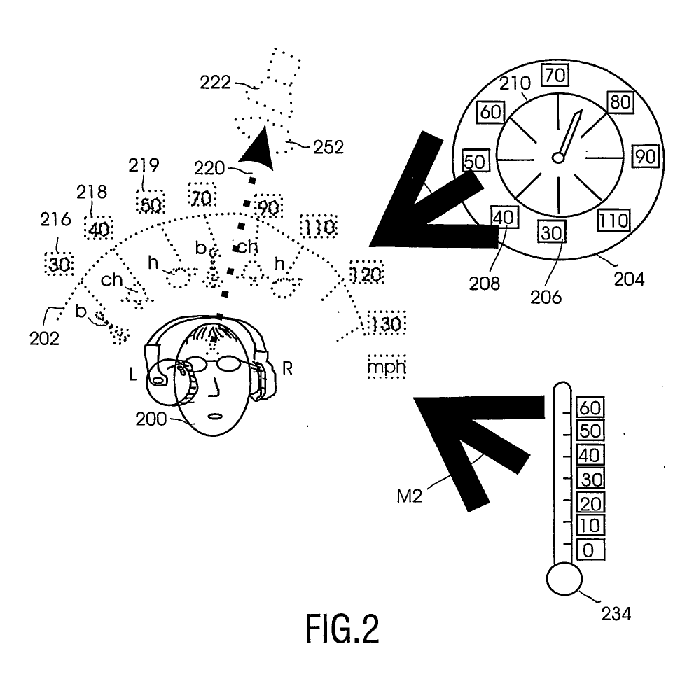

FIG. 2 schematically shows examples of mapping of numerical measurement values;

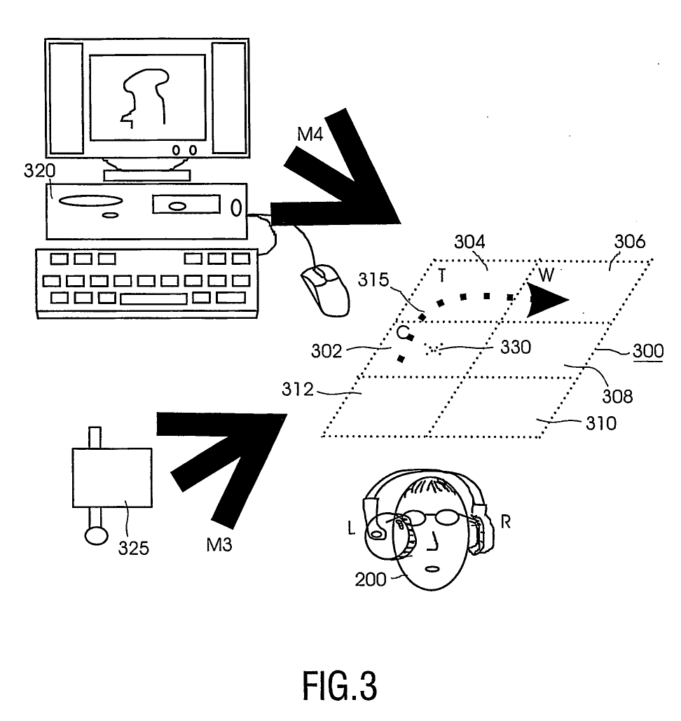

FIG. 3 schematically shows examples of mapping of nominal data variable values;

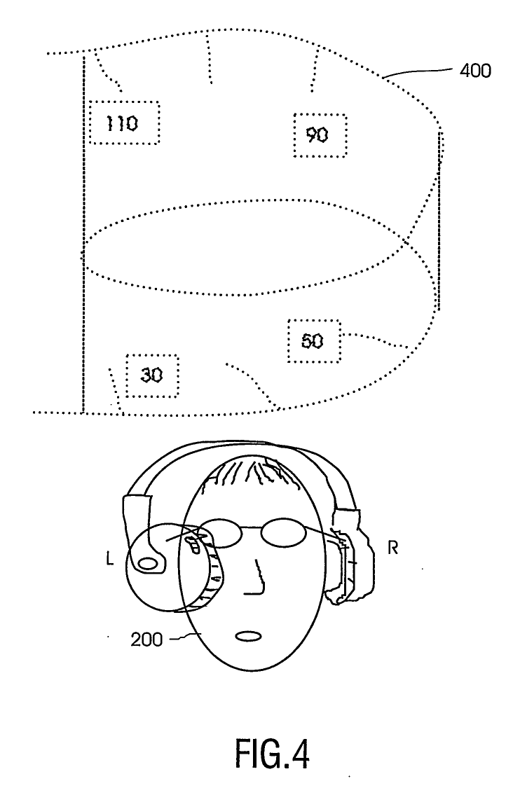

FIG. 4 schematically shows a virtual locus with multiple depths;

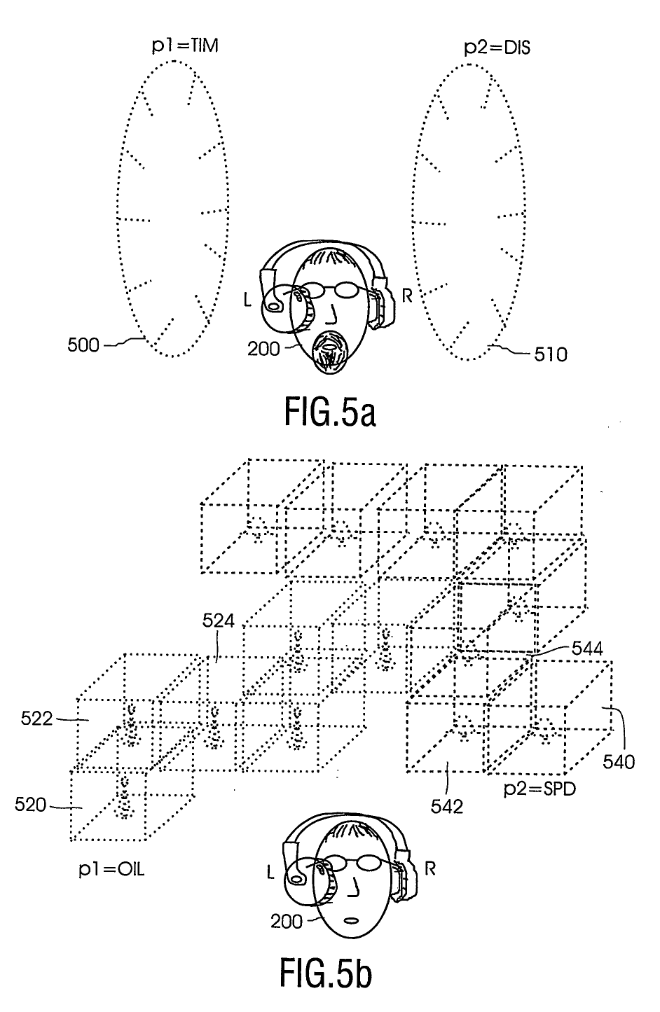

FIG. 5 schematically shows two examples of simultaneous presentation of two virtual loci;

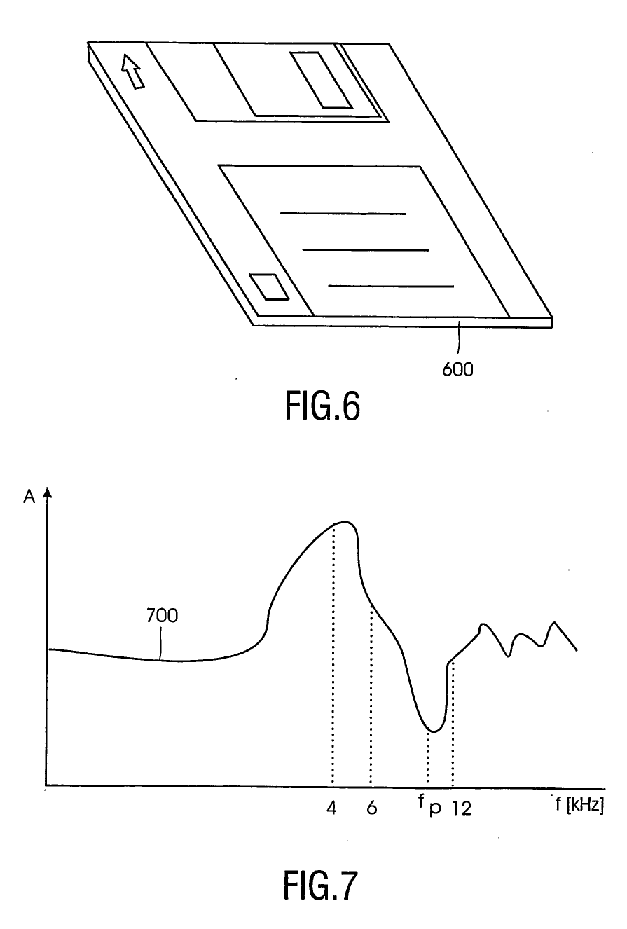

FIG. 6 schematically shows the data carrier; and

FIG. 7 schematically shows a head related transfer function HRTF.

In these Figures elements drawn dashed are optional, depending on the desired embodiment in FIG. 1, and virtual in the other Figures. Not all elements shown in the illustrative embodiments need be present in an alternative embodiment.

FIG. 1 shows the data representation apparatus 100 for presenting data by means of an audio signal o. It comprises an audio processing unit 102 which is arranged to deliver the audio signal o with a characteristic C tailored so that the audio signal o appears to originate from a desired position in space to a user 200, dependent on a data variable p. The data variable p can be the result of a physical measurement m or another specification, e.g. a mathematical number or a countable attribute of e.g. an email or another data set. The audio processing unit 102 is arranged to allocate to the audio signal o a first position 216 in FIG. 2 of a virtual sound source 222 in the case that the data variable p has the first value 206 and a second position 218 in the case that the data variable has the second value 208. The virtual sound source 222 is simulated by means of a sound production device 112 comprising at least two loudspeakers, e.g. headphones or the loudspeakers of a PC, a television or radio. The audio signal o may typically be derived by the audio processing unit 102 based on an input signal i. The input signal i can be e.g. music from an external audio source 114, e.g. a portable MP3 player, or can be internally generated audio from an internal audio source 116, e.g. a beep sound or music. The input signal i can be mono or multichannel audio.

The data variable may be received from a measurement device 104 or from a data variable delivering device 124, such as e.g. a disk reader in case the data variables are prestored on a disk, a memory, or a network connection. If all the data variables p are sequentially read from disk and converted to virtual sound source positions, a user 200 can quickly undertake some action in correspondence to the representation of a data variable p, such as pushing a button. A data variable distributor 122 is arranged to deliver the data variable p received from the measurement device 104, or the data variable delivering device 124, to the audio processing unit 102. The data variable distributor 122 can e.g. be configured to only deliver data variables from the measurement device 104, or it can be configured to deliver data variables from both the measurement device 104 and the data variable delivering device 124, e.g. in a temporally interleaved fashion. Both data variables can also be grouped in a code word or a new data variable value can be calculated as a function of both data variables. Additionally, the data variable distributor 122 may be configured to only pass a value of the data variable p in a predefined interval, or to which a priority value is allocated. E.g. if the data variables are linked to email messages, data variables like “urgent”, “normal”, “information”, etc. may be represented only if the email message has a priority value “professional email”. The interval or priority value may be specified to indicate a dangerous situation, e.g. a temperature is only represented if over a predetermined value, and otherwise the user is not bothered with temperature information. To achieve this, prioritization means 170 may be present. The prioritization means 170 may e.g. be embodied as a processor arranged to evaluate a set of rules on the data variable p, which only when satisfied lead to the transmission of a corresponding position pos to the audio processing unit 102.

FIG. 1b schematically shows a few example embodiments of the data variable distributor 122. It may comprise as an output connection a first connection 180, on which data variables at different times t0, t1, etc. are interleaved from different measurement devices or data variable delivering devices, according to predefined interleaving scheme. Alternatively or additionally a second connection 182 may be present, which in the example transmits a composed parameter to the audio processing unit 102, being a function of a first physical measurement m11 and a first delivered data variable pp. A third connection 184 only transmits a second physical measurement m12 as a parameter p13 if its value is greater than 20. The mapping unit 132 converts time series of parameters corresponding to e.g. different physical measurements to time series of positions pos, from which the audio processing unit generates virtual sound sources respectively for each time series. In a simple variant of the data representation apparatus 100, in which only a single type of measurement is inputted, the data distributor may be a simple electrical connection between the measurement device and the mapping unit 132.

The measurement device 104 can e.g. be a pace meter—measuring how many steps per minute the user 200 runs—or a heart rate meter. It is annoying that the user 200 repetitiously has to watch a display for his heart rate. This may interfere with his training and he may even trip over a bulge in the road while looking at the display. The audio processing unit 102 may be arranged so that the sound from the virtual source is always present, e.g. if the music from the MP3 player is positioned around the user's 200 head, or it may generate a beep every few seconds. The beep may be added to the sound or music listened to. E.g. an apparatus may alert a user 200 by means of the added beep while he is listening to music from a portable CD player, or in another application to sound of a movie on television.

The user 200 can specify that his desired running pace is mapped to a position straight in front of him, and slower paces are mapped over his head. Also, for a clock radio virtual sound positioning is very useful. With current clock radios if a user keeps sleeping after the clock radio starts playing in the morning, he only gets a feedback of the time when the radio program presenter announces it, e.g. every half hour during reading of the news. If the virtual sound source position moves, e.g. from the left to the right of the clock radio, the user 200 constantly gets a feedback of the time.

Professional applications may use other measurement devices. E.g. firemen often have to enter a building filled with thick smoke. With the audio representation apparatus 100, measurements that are hardly visible on displays can be presented by means of virtual sound sources.

A mapping unit 132 is present, arranged to map a collection of values of the data variable p to a locus of positions pos in three-dimensional space, such as e.g. a locus 202 in FIG. 2, or a two-dimensional locus 300 in FIG. 3. Preferably specification means 150 are also comprised, which is arranged to allow user 200 to specify a mapping according to his preference. E.g. he can map a number of nominal data variable p values to two-dimensional regions in space—such as a first region 302 and a second region 304—the regions having a size and position according to the user's 200 preference. The specification can be input by means of data input means 152. E.g. on a portable MP3 player or mobile phone there may be a touch pad present, on which the user 200 can specify the first and second region 302 and 304, by drawing small rectangles on top of a predefined zone representing a part of space around the user's 200 head. Alternatively a user may input data by means of keys or turning knobs on a car radio or onboard computer. The mapping unit may comprise a memory 134 storing map-related data or mapping functions. If the data input means 152 comprise a network connection—e.g. to the internet—it is also possible that e.g. a manufacturer of the data representation apparatus 100 downloads a new mapping.

Virtual sound sources can be created e.g. by stereo panning. The input audio signal i, e.g. mono music, is converted by the audio processing unit 102 to the output audio signal o, having two components, a first component for a first loudspeaker 160 and a second component for a second loudspeaker 161. An amplitude of the two components is determined so that the audio signal o appears to originate from a virtual sound position somewhere in between the two loudspeakers. A much more accurate positioning can be achieved by means of head related transfer functions HRTF. To achieve this result, the audio processing unit 102 may comprise a filter 140 for applying a HRTF to an input audio signal i to obtain the output audio signal o. For the first component a first HRTF is used. It represents how sound would travel, from a real sound source in the position of the virtual sound source, to a first ear of the user 200—in case he is wearing headphones the ear predominantly stimulated by the first loudspeaker 160 of the headphone. The input signal i is filtered with the first HRTF by the filter 140 to obtain the first component. To obtain the second component the input signal i is filtered with a second HRTF. HRTFs for all virtual sound source positions can be stored in a second memory 142. An example of a HRTF is shown in FIG. 7. E.g., the frequency fₚ of a pinna notch in the HRTF, resulting in a characteristic of the audio signal o being less energy in the frequency range around fₚ, can be used to simulate an elevation of a virtual sound source. More information can be found in “P. J. Bloom: Creating source elevation illusions by spectral Manipulation, Journal of the audio engineering society, v. 25, September 1977, pp. 560-565.” Information on presenting virtual sound sources by means of headphones can be found in patent WO0149066. More information on the use of HRTF to simulate virtual sound sources can be found in “F. L. Wightman and D. J. Kistler: Headphone simulation of free field listening. I: Stimulus synthesis. Journal of the acoustical society of America 85 no. 2, February 1989, pp. 858-867.” How to interpolate HRTFs for intermediate positions given a fixed number of measured HRTFs for a particular or generic user can be found in “L. W. P. Biscainho et al.: Using inter-positional transfer functions in 3D sound. Proceedings IEEE International Conference on Acoustics, Speech, and Signal Processsing, Orlando, USA, 2002, vol. II, pp. 1961-1964.”

Selection means 117 may be present, arranged to allow representation of a first set of data variable p values by a first type b of the audio signal o—e.g. a deep bass sound—and a second set of data variable p values by a second type ch—e.g. a chime—of the audio signal. The selection means 117 may e.g. form part of the internal audio source 116, or they may be incorporated in the audio processing unit 102. The selection means 117 may also comprise a speech generator 118 arranged to change the type of audio signal by generating a speech signal of the value of the data variable p in the position of the virtual sound source 222. E.g. a sound corresponding to the English word “seven” is generated at the position in space corresponding to a value of the data variable p substantially equal to seven.

FIG. 2 shows an example of a locus 202 of virtual sound source positions, corresponding to numerical data variable p values, extending around the user's 200 head. E.g. a first mapping Ml maps the values on a scale 210 of a measurement device 204—e.g. a speed meter of a car—to the locus 202. The mapping may e.g. be so that an angle on the scale 210 is proportional to an angle on the locus 202, or can comprise a nonlinear angle mapping function to a noncircular locus. E.g. the first position 216—representing 30 km/h in the example—is positioned at 50 degrees from the zenith above the user's 200 head, the second position 218—representing 40km/h—is positioned at 40 degrees from the zenith, a third position 219—representing 50 km/h—is positioned at 30 degrees from the zenith, etc. However if the user 200 decides that the difference between 30 km/h and 40 km/h is less important than the difference between 40 km/h and 50 km/h, he can devise a mapping with e.g. 5 degrees between the first position 216 and the second position 218, and 15 degrees between the second position 218 and the third position 219. Alternatively he may also specify a mapping in which there is no sound when he is driving substantially with the desired speed and only audio representation for speeds which are too low or to high. A second mapping M2 can e.g. map temperatures of a thermometer 234. On the locus 202, the first value 206 may correspond e.g. to a guitarlike sound at the first position 216, and the second value 208 may correspond to a chime sound at the second position 218. The mapping unit 132 may be arranged so that only a part of the scale 210 is mapped to the locus 202, e.g. only the low speeds. The speeds below a critical speed, e.g. 120 km/h may be mapped over a smaller part of the locus 202, with smaller intervalue angles, and speeds above 120 km/h may be mapped with larger intervalue angles. Parts of the scale 210 could even be missing. The user 200 can put the locus 202 anywhere he likes in three-dimensional space. E.g. he might prefer the locus to go around him in a horizontal plane, because it is more natural for him, or because in this way he can judge speed differences easier. In a variant of the audio processing unit 102, only the azimuth angle is determined by means of a HRTF and the height of the virtual sound source 222 is simulated by means of a pitch modification of the audio signal o. Arrow 220 indicates the position or direction in which the virtual sound source 222 is heard, being a kind of virtual pointer. Including in the term a position in space should be included that a virtual sound source appears to be situated not exactly at a well-defined point in space, but within a small region 252 of space, due to e.g. audio processing or the localization capabilities of the user 200.

FIG. 3 shows how nominal values can be mapped to regions of space. E.g. measuring device 325 may output one of three nominal values being cold C, tepid T and warm W. They are represented by means of a third mapping M3 with a virtual sound source in respectively the first region 302, the second region 304 and a third region 306. Allocating a virtual sound source to a region can be done by allocating it to a position 330 in the region, e.g. the center of the region. If there is an order between the nominal values, as in the case of temperatures, the mapping may follow an order path 315. This can be any path through the available regions 302, 304, etc., e.g. a zigzag path, spiral path, fractal path, etc.

Alternatively, emails received by a computer 320 may have attributes such as “urgent”, “company email” etc. These attributes can also be mapped to the regions by means of a fourth mapping M4. The computer 320 may also present certain commands or warning signals by mapping their nominal values.

If the regions 302, 308 . . . are used as columns, e.g. a first column constituted by the second region 304 and the third region 306, a second column constituted by the first region 302 and a fourth region 308, etc., other mappings can be realized. E.g. when shopping in a supermarket, the columns may represent types of product to buy, or in a work environment they may represent chores. E.g. a sound every hour in the third region 306, can indicate that there are two chores left in the first column, representing emails to send. A sound the first region 302, can indicate that there is only one person to call today.

FIG. 4 schematically shows a curvilinear second locus 400 with multiple depths. The amplitude of the audio signal o can be used to simulate depth, but also other characteristics can be used such as added reverberation. Such a second curvilinear locus 400 is advantageous when the data variable has some importance to the user 200, as e.g. an email changing from plain to urgent.

FIG. 5a shows how a first and a second instance of data variable p can be presented simultaneously, e.g. a first data variable p1 being the time and a second data variable p2 being a distance traveled. To avoid that the user 200 confuses different data variable representations, a third locus 500 may be presented e.g. at the right of the user 200, and a fourth locus 510 may be presented e.g. at the left. This is especially important if the virtual sound source of the two loci emit a similarly sounding sound. Both sounds can be emitted at the same time instance or temporally interleaved. Both sounds can also traverse the same locus, e.g. the first curvilinear locus 202, as long as they sound different. And preferably they are emitted a different time instances.

FIG. 5b shows another example of how two loci corresponding to different data variables p can be presented simultaneously. The loci may be interweaved intricately, as long as differently sounding sounds are used for their virtual sound sources. Values of a first data variable p1 are represented in three-dimensional regions 520, 522, 524, etc.—shown dotted—, and values of a second data variable p2 are represented in three-dimensional regions 540, 542, 544, etc.—shown dashed.

An audio source 114, 116 arranged to deliver an input audio signal i, a source 104, 124 of the data variable p, the sound production device 112, and the data representation apparatus 100 for presenting data by means of the audio signal o may together form a single system. Its components may be realized in different possible physical combinations, depending on whether the system is portable or installed in a room or a car. Signal connections may be realized wired or wireless by any known technique. A head tracker may be present to track the orientation of the user's 200 head, allowing the audio processing unit to reselect a HRTF for a new orientation, so that the virtual sound source 222 seems stationary in space. If headphones are used as a sound production device, they may be arranged to partially pass sounds form the environment for reasons of safety. The data representation apparatus may be embodied in different types of apparatus, such as a mobile phone, a portable computer, a portable audio player, a home computer, a car radio, a television set, etc.

It should be noted that the above-mentioned embodiments illustrate rather than limit the invention and that those skilled in the art are able to design alternatives, without departing from the scope of the claims. Apart from combinations of elements of the invention as combined in the claims, other combinations of the elements within the scope of the invention as perceived by one skilled in the art are covered by the invention. Any combination of elements can be realized in a single dedicated element. Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

The invention can be implemented by means of hardware or by means of software running on a computer, and previously stored on a data carrier or transmitted over a signal transmission system.

1. Data representation apparatus for representing data by means of an audio signal, comprising
an audio processing unit arranged to deliver the audio signal with a characteristic dependent upon a positionless data variable capable of having a first value and a second value,
characterized in that
the data representation apparatus comprises a mapping unit, arranged to map the first value of the data variable to a first position in three-dimensional space, and the second value of the data variable to a second position in three-dimensional space; and
the audio processing unit is arranged to change the characteristic, resulting in the audio signal appearing to originate from the first position for the data variable having the first value respectively the second position for the data variable having the second value, to a user listening to the audio signal.

2. Data representation apparatus as claimed in claim 1, wherein the audio processing unit comprises a filter for applying a head related transfer functions to an input audio signal to obtain the output audio signal appearing to originate from the first position respectively the second position.

3. Data representation apparatus as claimed in claim 1, comprising a data variable distributor, capable of delivering the data variable derivable from a measurement from a measurement device to the audio processing unit.

4. Data representation apparatus as claimed in claim 1, wherein the mapping unit is arranged to map a collection of nominal values of the data variable to predetermined regions of three-dimensional space.

5. Data representation apparatus as claimed in claim 1, wherein the mapping unit is arranged to map a collection of numerical values of the data variable to positions on a curvilinear locus in three-dimensional space.

6. Data representation apparatus as claimed in claim 1, wherein specification means are comprised, arranged to allow a specification of a preferred mapping for the mapping unit.

7. Data representation apparatus as claimed in claim 1, wherein selection means are present, arranged to allow presentation of a first set of data variable values by a first type of the audio signal and a second set of data variable values by a second type of the audio signal.

8. A system for representing data by means of an audio signal, comprising:
an audio source arranged to deliver an input audio signal;
a source of a data variable capable of having a first value and a second value;
a sound production device; and
a data representation apparatus for representing data by means of the audio signal, the data representation apparatus comprising an audio processing unit arranged to deliver the audio signal to the sound production device with a characteristic dependent on the data variable,
characterized in that the data representation apparatus further comprises a mapping unit, arranged to map by means of a mapping the first value of the data variable to a first position in three-dimensional space, and the second value of the data variable to a second position in three-dimensional space; and
the audio processing unit is arranged to change the characteristic, resulting in the audio signal appearing to originate from the first position for the data variable having the first value respectively the second position for the data variable having the second value, to a user listening to the audio signal.

9. A method of representing data by means of an audio signal, comprising an audio processing step delivering the audio signal with a characteristic dependent on a data variable, capable of having a first value and a second value,
characterized in that
a mapping is effected mapping the first value of the data variable to a first position in three-dimensional space, and the second value of the data variable to a second position in three-dimensional space; and
the audio processing step changes the characteristic, resulting in the audio signal appearing to originate from the first position for the data variable having the first value respectively the second position for the data variable having the second value, to a user listening to the audio signal.

10. A computer program for execution by a processor, enabling the processor to execute the method of claim 9.

11. A data carrier storing the computer program of claim 10.
